(19) United States
(12) Patent Application Publication
(10) Pub. No.: US 2022/0135810 A1
(43) Pub. Date: May 5, 2022

(54) Use of special thiol compounds to improve the storage stability of compositions based on epoxy resins containing amine compounds

(71) Applicant: Hilti Aktiengesellschaft, Schaan (LI)

(72) Inventors: Phillip Jochmann, Ulm (DE); Juliane Marauska, Kaltenkirchen (DE); Martin Lang, Planegg (DE); Stefan Schlenk, Landsberg (DE); Katja Student, Augsburg (DE)

(73) Assignee: Hilti Aktiengesellschaft, Schaan (LI)

(21) Appl. No.: 17/431,449

(22) PCT Filed: Feb. 6, 2020
(86) PCT No.: PCT/EP2020/052962

§ 371 Date: Aug. 17, 2021

(30) Foreign Application Priority Data
Feb. 20, 2019 (EP) 19158319.4

(51) Int. Cl. C09D 5/18; C09D 163/00; C08G 59/24; C08G 59/50; C08G 59/66; C08G 59/56

(52) U.S. Cl. CPC C09D 5/185; C09D 163/00; C08G 59/56; C08G 59/504; C08G 59/66; C08G 59/245

(57) ABSTRACT

A composition that forms an insulating layer contains an epoxy-thiol-based binder. Because the expansion rate of the composition is relatively high, coatings having the layer thickness required for the relevant fire resistance duration can be applied in a simple and rapid manner, and it is possible to reduce the layer thickness to a minimum while still achieving a good insulating effect. The composition is particularly suitable for fire-protection, in particular as a coating for metal and non-metal substrates, e.g., steel components such as supports, beams, and truss members, to increase the fire resistance duration thereof.

The present invention relates to the use of certain thiol compounds, in particular thiol compounds which are free from electrophilic groups, to improve the storage stability of compositions based on epoxy resins containing amine compounds. In particular, the present invention relates to the use of thiol compounds which are free from ester groups, to improve the storage stability of compositions which form an insulating layer and are based on epoxy resins containing amine compounds, which compositions contain one or more additives which form an insulation layer.

Compositions which form an insulating layer, also referred to as intumescent compositions, are usually applied to the surface of components to form coatings, in order to protect said components from fire or against the effects of intense heat, for example as a result of a fire. Steel constructions are now an integral part of modern architecture, even though they have a decisive disadvantage in comparison with reinforced concrete construction. Above about 500° C., the load-carrying capacity of steel is considerably reduced, i.e. the steel loses its stability and its bearing capacity. A temperature which is critical for the load-bearing capacity of the structure can be reached in approximately just 5-10 minutes depending on the fire load, for example in the case of direct exposure to fire (approximately 1000° C.). It is now the aim of fire protection, in particular of steel fire protection, to extend the period of time before the steel structure loses load-bearing capacity in the event of a fire, in order to save lives and valuable property.

Various systems for this purpose exist in the prior art.

In the field of coatings, it is known from DE 4141858 A1 to use bisphenol A diglycidyl ether, which has been extended using dimercapto compounds or mercapto carboxylic acids and bisphenol A, as a binder which is cured using amines.

WO 2012/082224 A1, for example, describes a composition which comprises an epoxy resin, at least one polythiol compound as a curing agent and at least one catalyst. A similar composition which comprises an epoxy resin and an amine as a curing agent is described, inter alia, in WO 1998/12270 A1 or WO 2016/170122 A1.

WO 2014/095502 A1 further describes a composition which forms an insulating layer, in particular a composition having intumescent properties, which contains an epoxy thiol-based binder. Amine compounds can be used as a further curing agent, what is referred to as the co-curing agent, and as a catalyst.

The inventors have now discovered that thiol compounds per se and compositions containing said compounds have a very limited storage stability when stored together with amines, as are often used as catalysts or as curing agents or co-curing agents. Undesired reactions can occur during storage, which lead to decomposition of the thiol compounds. This can manifest in different ways. An increase in viscosity is often observed during storage, which has a negative effect on the handling and application of the compositions. If the thiol compound is used as a curing agent, the decomposition thereof can negatively influence the curing times and/or the curing properties (curing) of the composition. For example, the processing time specified by the manufacturer may change or the composition may no longer cure completely or all the way through, which in turn negatively affects the properties of the cured composition. The decomposition of the thiol compounds often also leads to smaller, volatile thiol compounds which have an unpleasant odor.

One way to avoid this disadvantage is to package the compositions such that the thiol compounds and the amine compounds are stored separately from one another. However, this restricts the development of new compositions which contain a thiol compound and which are to be packaged as two-component systems.

The problem addressed by the invention is therefore that of providing compositions based on epoxy compounds, which compositions contain thiol compounds and amine compounds and have an improved storage stability.

This problem is solved by the use according to claim 1 and claim 2. Preferred embodiments can be found in the dependent claims.

For an improved understanding of the invention, the following explanations of the terminology used herein are considered useful. In the context of the invention:
“thiol compound” means a compound of the structure RSH, where R≠H, and therefore an organic compound with a thiol group (—SH) as a functional group, which is able to react with epoxides;
“amine compound” means a compound which is formally derived from ammonia by replacing one, two or three hydrogen atoms with hydrocarbon groups, and which has the structures: RNH₂ (primary amines), R₂NH (secondary amines) or R₃N (tertiary amines);
“ester group-free” in connection with thiol compounds means that the thiol compound does not contain a carboxylic acid ester group (R¹C(O)OR²); it means in particular that the functional group (—SH) is not bonded to a group or the backbone of a molecule via a linker containing a carboxylic acid ester unit, and that the group or the backbone also does not contain a carboxylic acid ester group;
“multifunctional” means that the corresponding compound has more than one functional group per molecule; multifunctional in the context of epoxy compounds therefore means that said epoxy compounds have more than one epoxy group per molecule, and, in relation to thiol compounds, means that said thiol compounds have at least two thiol groups per molecule; the total number of the respective functional groups is the functionality of the corresponding compound;
“skeleton” of the epoxy resin or of the thiol-functionalized compound means the relevant other part of the molecule, to which the functional epoxy or thiol group can be attached;
“chemical intumescence” means the formation of a voluminous, insulating ash layer by means of compounds which are matched to one another and react with one another under the effect of heat;
“physical intumescence” means the formation of a voluminous, insulating layer by means of expansion of a compound that releases gases under the effect of heat, without a chemical reaction between two compounds having taken place, thereby causing the volume of the compound to increase by a multiple of the original volume;
“which forms an insulating layer” means that, in the event of a fire, a firm micro-porous carbon foam is formed, such that the formed fine-pored and thick foam layer, which is referred to as the ash crust, insulates a substrate against heat, depending on the composition of the layer;
a “carbon source” is an organic compound which leaves behind a carbon skeleton due to incomplete combustion, and does not combust completely to form carbon dioxide and water (carbonization); these compounds are also referred to as “carbon-skeleton formers;”
an “acid former” is a compound which, under the effect of heat, i.e. above approximately 150° C., forms a non-volatile acid, for example due to decomposition, and thereby acts as a catalyst for carbonization; in addition, it may contribute to lowering the viscosity of the melt of the binder; the term “dehydrogenation catalyst” is therefore used synonymously in this context;
a “blowing agent” is a compound that decomposes at an elevated temperature, with the development of inert, i.e. non-combustible gases, and expands the carbon skeleton formed by the carbonization, and optionally the softened binder, into a foam (intumescence); this term is used synonymously with “gas fomer,”
an “ash-crust stabilizer” is what is referred to as a skeleton-forming compound which stabilizes the carbon skeleton (ash crust) formed from the interaction of the carbon formation from the carbon source and the gas from the blowing agent, or the physical intumescence. The fundamental mode of action is in this case that the inherently very soft carbon layers being formed are mechanically strengthened by inorganic compounds. The addition an ash crust stabilizer of this kind contributes to significant stabilization of the intumescence crust in the event of a fire, because these additives increase the mechanical strength of the intumescent layer and/or prevent it from dripping off, as a result of which the insulating effect of the foam is maintained or enhanced.
an “oligomer” is a molecule having 2 to 5 repetition units and a “polymer” is a molecule having 6 or more repetition units and said molecules can have structures that are linear, branched, star-shaped, twisted, hyper-branched or crosslinked; polymers can have a single type of repetition unit (“homopolymers”) or they can have more than one type of repetition unit (“copolymers”). As used herein, “resin” is synonymous with polymer.
“Epoxy equivalent weight” means the amount of epoxy resin in [g] that has an equivalent [eq] epoxy function and is calculated from the molar mass M in [g/mol] divided by the functionality f in [eq/mol]; (EEW [g/eq]).

Surprisingly, it has been found that an improved storage stability of compositions containing thiol compounds and amine compounds can be achieved if thiol compounds free of ester groups are used.

A first subject of the invention is accordingly the use of an ester group-free thiol compound in a composition containing amine compounds, to improve the storage stability.

The composition can be any composition which contains both thiol compounds and amine compounds.

In particular, the composition is an epoxy-based composition, i.e. a curing composition having an epoxy-based binder.

The composition is very particularly a fire protection composition, more specifically an intumescent composition which contains an epoxy-based binder, an amine compound and intumescent additives, as are explained in greater detail herein.

The subject of the invention therefore also includes the use of an ester group-free thiol compound for the preparation of a composition containing storage-stable amine compounds, in particular an epoxy-based composition, very particularly a fire protection composition, more specifically an intumescent composition which contains an epoxy-based binder.

A further subject of the invention is therefore an epoxy-based composition obtainable by using ester group-free thiol compounds, in particular a composition having improved storage stability that forms an insulating layer.

As a result of the invention it is possible to provide storage-stable compositions which contain both thiol compounds and amine compounds, in particular compositions based on epoxy resins, which compositions simultaneously contain amine compounds and thiol compounds. In this case it is irrelevant whether it is the thiol compound that is used as a curing agent, as a co-curing agent or as an additive, or the amine compound.

As a result of the invention it is in particular possible to provide compositions containing amine compounds, in particular fire protection compositions having an epoxy-thiol-based binder, such as compositions which form an insulating layer. In this case, two-component compositions can be formulated, inter alia, one component of which contains one thiol compound and one amine compound and allows storage over a longer period of time without negative effects on the viscosity or the curing behavior of the composition being observed, compared with compositions which contain thiol compounds having ester groups in the structure.

Thiol Compounds

According to the invention, any compound having at least two thiol groups (—SH) that can react with the epoxy resins can be used, provided that the thiol compound is free of ester groups.

Each thiol group is in this case attached to a skeleton either directly or via a linker, provided that the linker and the skeleton are free of ester groups.

The thiol compound can have any of a wide variety of skeletons which can be the same or different. The skeleton can be a monomer, an oligomer or a polymer.

In some embodiments of the present invention, the skeletons comprise monomers, oligomers, or polymers having a molecular weight (Mw) of 50,000 g/mol or less, preferably 25,000 g/mol or less, more preferably 10,000 g/mol or less, still more preferably 5,000 g/mol or less, more preferably 2,000 g/mol or less, and most preferably 1,000 g/mol or less.

Alkanediols, alkylene glycols, sugars, polyvalent derivatives thereof or mixtures thereof, amines such as ethylenediamine and hexamethylenediamine, and thiols can be mentioned as examples of monomers which are suitable as skeletons. The following can be mentioned as examples of oligomers or polymers which are suitable as skeletons: polyalkylene oxide, polyvinyl alcohol, polydiene, hydrogenated polydiene, alkyd, polyolefin, halogenated polyolefin, polymercaptan, and copolymers or mixtures thereof.

In preferred embodiments of the invention, the skeleton is a polyhydric alcohol or a polyhydric amine, which may be monomeric, oligomeric or polymeric. The skeleton is more preferably a polyhydric alcohol.

The following may be mentioned as examples of polyhydric alcohols which are suitable as skeletons: alkanediols such as butanediol, pentanediol, hexanediol, alkylene glycols, such as ethylene glycol, propylene glycol and polypropylene glycol, glycerin, 2-(hydroxymethyl)propane-1,3-diol, 1,1,1-tris(hydroxymethyl)ethane, 1,1,1-trimethylolpropane, di(trimethylolpropane), tricyclodecanedimethylol, 2,2,4-trimethyl-1,3-pentanediol, bisphenol A, cyclohexanedimethanol, alkoxylated and/or ethoxylated and/or propoxylated derivatives of neopentyl glycol, tertraethylene glycol cyclohexanedimethanol, hexanediol, 2-(hydroxymethyl)propane-1,3-diol, 1,1,1-tris(hydroxymethyl)ethane, 1,1,1-trimethylolpropane and castor oil, pentaerythritol, sugar, polyvalent derivatives thereof or mixtures thereof.

Any units that are suitable for bonding the skeleton and the functional group can be used as linkers. For thiol compounds, the linker is preferably selected from structures (I) to (VI):

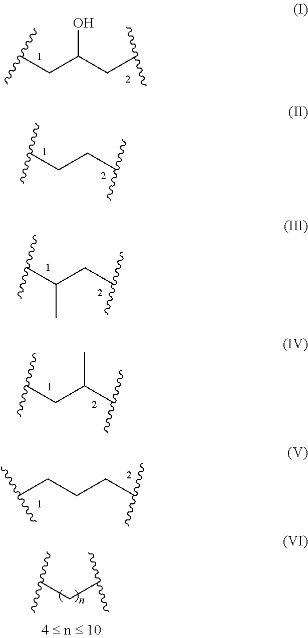

2-hydroxy-3-mercaptopropyl derivatives of monoalcohols, diols, triols, tetraols, pentaols or other polyols are suitable ester group-free thiol compounds. Mixtures of alcohols can also be used in this case as the basis for the thiol compound. In this regard, reference is made to WO 99/51663 A1.

Preferred thiol compounds free of ester groups are selected from the group consisting of 2-hydroxy-3-mercaptopropyl derivatives of monoalcohols or polyols, mercaptan-terminated polymers, such as mercaptan-terminated polyether, tris-(2′-hydroxy-3′-mercaptoprop-1′-yl)-trimethylolpropane, all forms of ethoxylated tis-(2′-hydroxy-3′-mercaptoprop-1′-yl)-trimethylolpropane, all forms of propoxylated tris-(2′-hydroxy-3′-mercaptoprop-1′-yl)-trimethylolpropane, CeTePox 2200H (CTP), dithioglycerol, trithioglycerol, poly(ethylene glycol)methyl ether thiol, 2[(3-aminopropyl)amino]ethanethiol, dithiothreitol, phenylic and benzylic thiols, such as benzenedithiol or dimercaptostilbene, tetra(ethylene glycol)dithiol, 2-methylsulfanylpropane-1,3-dithiol, 3-ethoxypropane-1,2-dithiol, 3-aminopropane-1,2-dithiol and 3-anilinopropane-1,2-dithiol.

Particularly suitable ester group-free thiol compounds are selected from the group consisting of liquid, 2-hydroxy-3-mercapto-1-propyl-substituted aliphatic alcohols, which are optionally ethoxylated or propoxylated, tris-(2′-hydroxy-3′-mercaptopropyl)-trimethylolpropane, ethoxylated tris-(2′-hydroxy-3′-mercaptopropyl)-trimethylolpropane, propoxylated tris-(2′-hydroxy-3′-mercaptopropyl)-trimethylolpropane, 1,6-hexanedithiol, dithioglycerol, trithioglycerol, poly(ethylene glycol)methyl ether thiol, 2-[(3-aminopropyl)amino]ethanethiol, dithiothreitol, phenylic and benzylic thiols such as benzenedithiols or dimercaptostilbene, hexadecanedithiol, tetra(ethylene glycol)dithiol, 2-methylsulfanylpropane-1,3-dithiol, 3-ethoxypropane-1,2-dithiol, 3-aminopropane-1,2-dithiol, 3-anilinopropane-1,2-dithiol, and liquid thiol-terminated polysulfide polymers.

The thiol compound can also be selected from one or more curing agents of the trade names Capcure 3-800 (BASF), Capcure LOF (BASF), GPM 800 (Gabriel Performance Products), GPM 800 LO (Gabriel Performance Products), Polythiol QE 340M (Toray), CeTePox 2200H (CTP), Thioplast G4 (Akzo Nobel) and Thioplast G44 (Akzo Nobel).

The ester group-free thiol compound can be used alone or as a mixture of two or more different ester group-free thiol compounds.

In a preferred embodiment of the invention, the ester group-free thiol compounds which have just been described are used to improve the storage stability of a composition which contains an epoxy resin, an amine compound and, in addition, a thiol compound. In this case, the epoxy resin acts as a binder, and the amine compound or the thiol compound acts as a curing or co-curing agent or as a catalyst. The composition is usually a two-component or multi-component composition, one component of which contains the epoxy resin and the other component contains the thiol compound and the amine compound, such that the composition only cures when the components are mixed.

In a further preferred embodiment of the invention, the ester group-free thiol compounds which have just been described are used to improve the storage stability of a composition which forms an insulating layer, which composition contains an epoxy resin, an additive which forms an insulating layer, or a mixture of additives which form an insulating layer, an amine compound and a thiol compound. The epoxy resin acts as a binder, the amine compound or the thiol compound acts as a curing or co-curing agent or as a catalyst, and the additive which forms an insulating layer, or the mixture of additives which form an insulating layer, acts as a foaming agent (chemical intumescence). The composition which forms an insulating layer is usually a two-component or multi-component composition, one component of which contains the epoxide, and the or one other component contains the thiol compound and the amine compound, such that the composition only cures when the components are mixed. One of the components or the two components in this case contain additives, the additive which forms an insulating layer or the mixture of additives which form an insulating layer, which, in the event of a fire, leads to an expansion (intumescence) of the ash crust which forms.

Epoxy Compounds

Epoxy resins which are common in epoxy chemistry are suitable as the epoxy resin. These are obtained in a known manner, for example from the oxidation of the corresponding olefins or from the reaction of epichlorohydrin with the corresponding polyols, polyphenols or amines. Basic information about epoxy resins and examples thereof can be found in the “Epoxy Resins” chapter of the Encyclopedia of Polymer Sciences and Technology, Vol. 9, Wiley-Interscience, 2004. Examples of suitable epoxy resins that should be mentioned are reaction products of polyhydroxy compounds, in particular polyvalent phenols or phenol-aldehyde condensates, with epihalohydrins or the precursors thereof, in particular:
a) reaction products of epichlorohydrin with bisphenol A;
b) reaction products of epichlorohydrin with bisphenol S
c) epoxy novolacs based on phenol or cresol;
d) aromatic glycidyl amine resins;
e) epoxy resins which do not have aromatic structural units;

as well as mixtures of two or more of such epoxy resins in any desired ratio and in any desired degree of purity.

What are known as polyepoxy liquid resins, hereinafter referred to as “liquid resin,” are particularly suitable as the epoxy resin. These have a glass transition temperature which is usually below 25° C., in contrast to what are known as solid resins, which have a glass transition temperature above 25° C. and can be crushed to form powders which are pourable at 25° C. Suitable compounds are the glycidylization products of:
dihydroxybenzene derivatives such as resorcinol, hydroquinone and pyrocatechol;
further bisphenols or polyphenols such as bis-(4-hydroxy-3-methylphenyl)-methane, 2,2-bis-(4-hydroxy-3-methylphenyl)-propane (bisphenol C), bis-(3,5-dimethyl-4-hydroxyphenyl)-methane, 2,2-bis-(3,5-dimethyl-4-hydroxyphenyl)-propane, 2,2-bis-(3,5-dibromo-4-hydroxyphenyl)-propane, 2,2-bis-(4-hydroxy-3-tert-butylphenyl)-propane, 2,2-bis-(4-hydroxyphenyl)-butane (bisphenol B), 3,3-bis-(4-hydroxyphenyl)-pentane, 3,4-bis-(4-hydroxyphenyl)-hexane, 4,4-bis-(4-hydroxyphenyl)-heptane, 2,4-bis-(4-hydroxyphenyl)-2-methylbutane, 2,4-bis-(3,5-dimethyl-4-hydroxyphenyl)-2-methylbutane, 1,1-bis-(4-hydroxyphenyl)-cyclohexane (bisphenol Z), 1,1-bis-(4-hydroxyphenyl)-3,3,5-trimethylcyclohexane (bisphenol TMC), 1,1-bis-(4-hydroxyphenyl)-1-phenyl-ethane, 1,4-bis[2-(4-hydroxyphenyl)-2-propyl]-benzene (bisphenol P), 1,3-bis-[2-(4-hydroxyphenyl)-2-propy]-benzene (bisphenol M), 4,4′-dihydroxydiphenyl (DOD), 4,4′-dihydroxybenzophenone, bis-(2-hydroxynaphth-1-yl)-methane, bis-(4-hydroxynaphth-1-yl)-methane, 1,5-dihydroxy-naphthalene, tris-(4-hydroxyphenyl)-methane, 1,1,2,2-tetrakis-(4-hydroxyphenyl)-ethane, bis-(4-hydroxyphenyl)-ether, bis-(4-hydroxyphenyl)sulfone;
condensation products, obtained under acidic conditions, of phenols with formaldehyde, such as phenol novolacs or cresol novolacs, also referred to as bisphenol F novolacs;
aromatic amines, such as aniline, toluidine, 4-aminophenol, 4,4′-methylenediphenyldiamine (MDA), 4,4′-methylenediphenyldi-(N-methyl)-amine, 4,4′-[1,4-phenylene-bis-(1-methyl-ethylidene)]-bisaniline (bisaniline P), 4,4′-[1,3-phenylene-bis-(1-methyl-ethylidene)]-bisaniline (bisaniline M);
as well as mixtures of two or more of such epoxy resins in any desired ratio and in any desired degree of purity.

More preferred are reaction products of epichlorohydrin with bisphenol A having an epoxy equivalent weight (EEW)≤550 g/eq; reaction products of epichlorohydrin with bisphenol F, the simplest representative of the novolacs, having an EEW≤500 g/eq; any desired mixtures of these two reaction products, reaction products of any desired mixture of bisphenol A and bisphenol F with epichlorohydrin, epoxy resins such as hydantoin-based epoxy resins or diglycidyl ethers of hydrogenated bisphenol A or bisphenol F; and mixtures of two or more such epoxy resins in any desired ratio and in any desired degree of purity.

Particularly preferred are reaction products of epichlorohydrin with bisphenol A having an EEW≤330 g/eq; reaction products of epichlorohydrin with bisphenol F, the simplest representative of the novolacs, having an EEW s 300 g/eq; any desired mixtures of these two reaction products, reaction products of any desired mixture of bisphenol A and bisphenol F with epichlorohydrin having an EEW≤330 g/eq, 5,5-dimethyl-1,3-bis(2,3-epoxypropyl)-2,4-imidazolidinedione; 2,2-bis[4-(2,3-epoxypropoxy)-cyclohexyl]propane; as well as mixtures of two or more such epoxy resins in any desired ratio and in any desired degree of purity.

Very particularly preferred are reaction products of epichlorohydrin with bisphenol A having an EEW≤200 g/eq, such as Epilox® A 17-01, Epilox® A 18-00, Epilox® A 19-00, Epilox® A 19-02, Epilox® A 19-03 or Epilox® A 19-04 from Leuna-Harze GmbH, represented by the following formula, in which 0≤n≤0.2;

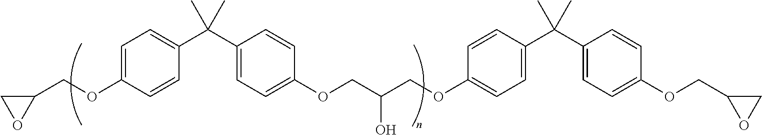

reaction products of epichlorohydrin with bisphenol F, the simplest representative of the novolacs, having an EEW≤185 g/eq, such as Epilox® F 16-01 or Epilox® F 17-00 from Leuna-Harze GmbH, represented by the following formula, in which 0≤n≤0.2;

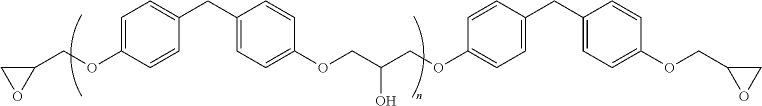

and mixtures of two or more such epoxy resins in any desired ratio and in any desired degree of purity, such as Epilox® AF 18-30, Epilox® 18-50 or Epilox® T 19-27 from Leuna-Harze GmbH, and reaction products of any desired mixture of bisphenol A and bisphenol F with epichlorohydrin having an EEW≤200 g/eq.

As the epoxy resin, an aliphatic or cycloaliphatic polyepoxide is also suitable, such as:
a glycidyl ether of a saturated or unsaturated, branched or unbranched, cyclic or open-chain C₂- to C₃₀-diol, such as ethylene glycol, propylene glycol, butylene glycol, hexanediol, octanediol, a polypropylene glycol, dimethylol cyclohexane, neopentyl glycol or dibromo-neopentyl glycol;
a glycidyl ether of a tri- or tetrafunctional, saturated or unsaturated, branched or unbranched, cyclic or open-chain polyol, such as castor oil, trimethylolpropane, trimethylolethane, pentaerythritol, sorbitol or glycerol, and alkoxylated glycerol or alkoxylated trimethylolpropane;
a hydrogenated bisphenol-A-, -F- or -A/F-liquid resin, or the glycidylization products of hydrogenated bisphenol-A, -F or -A/F respectively;
an N-glycidyl derivative of amides or heterocyclic nitrogen bases, such as triglycidyl cyanurate and triglycidyl isocyanurate, and reaction products of epichlorohydrin and hydantoin.

A bisphenol A-, F- or A/F-solid resin, which has a similar structure to the liquid resins of the above two formulas already mentioned, but has a value of 2 to 12 instead of the index n, and a glass transition temperature above of 25° C., is also a possible epoxy resin.

Finally, epoxy resins obtained from the oxidation of olefins, for example from the oxidation of vinylcyclohexene, dicyclopentadiene, cyclohexadiene, cyclododecadiene, cyclododecatriene, isoprene, 1,5-hexadiene, butadiene, polybutadiene or divinylbenzene, are also suitable as the epoxy resin.

Depending on the functionality of the epoxy resin, the degree of crosslinking of the binder, and therefore the strength of the resulting coating and the elastic properties thereof, can be adjusted. At the same time, this has a direct impact on the expansion of the ash crust that can be achieved in the event of a fire.

Reactive Diluent

By adding at least one reactive diluent, the viscosity of the composition can be adjusted or adapted according to the application properties.

In one embodiment of the invention, the composition therefore contains, as reactive diluents, further compounds containing epoxy groups, if necessary. These compounds contain one or more epoxy groups. In principle, any low-viscosity compound which carries at least one epoxy group per molecule can be used. Two or more different reactive diluents can be combined. Suitable examples are allyl glycidyl ether, butyl glycidyl ether (BGE), 2-ethylhexyl glycidyl ether, alkyl glycidyl ether (C₁₂-C₁₄), tridecyl glycidyl ether, phenyl glycidyl ether (PGE), o-cresol glycidyl ether (CGE), p-tert-butyl glycidyl ether, resorcinol diglycidyl ether (RDGE), 1,4-butanediol diglycidyl ether (BDGE), 1,6-hexanediol diglycidyl ether (HDGE), cyclohexanedimethanol diglycidyl ether, neopentylglycol diglycidyl ether, trimethylolpropane triglycidyl ether, glycerol triglycidyl ether, polypropylene glycol diglycidyl ether and epoxidized vegetable oils such as epoxidized linseed oil and epoxidized castor oil.

In the compositions described herein, the relative proportion of epoxy resins to thiol compounds can be characterized by the reactive equivalent ratio, which is the ratio of the number of all epoxy groups in the composition to the number of thiol groups in the composition. The reactive equivalent ratio is 0.1 to 10:1, preferably 0.2 to 5:1, more preferably 0.3 to 3:1, even more preferably 0.5 to 2:1 and even more preferably 0.75 to 1.25:1.

Amine Compounds

An amine curing agent which is common for epoxy resins can optionally be used as an additional curing component, also known as a co-curing agent. Suitable examples can be found in the “Epoxy Resins” chapter of the Encyclopedia of Polymer Sciences and Technology, Vol. 9, Wiley-Interscience, 2004. In particular aliphatic or aromatic amines, amidoamines, polyamides, polyamine-epoxy resin adducts and/or ketimines have proven successful. The amine curing agents can be used alone or as a mixture of two or more compounds. Examples are ethylenediamine, propylenediamine, hexamethylenediamine, diethylenetriamine (DETA), tetraethylenetetramine (TETA), isophoronediamine (IPDA), m-xylylenediamine (mXDA), N-methylbenzylamine (NMB) or Ancamide® (Air Products), diethylaminopropylamine (DEAPA), N-aminoethylpiperazine (N-AEP), diaminodiphenyl sulfone (DDS), 1,8-diamino-p-menthan (MDA). Polyetheramines such as Jeffamine® D-230 (Huntsman), Jeffamine® D-400 (Huntsman) and Jeffamine® T-403 (Huntsman) can also be used.

The coating properties can be adjusted using a mixture of a thiol compound and an amine compound as a curing agent for the epoxy resin, which mixture is selected accordingly.

Catalyst

The composition can also contain a catalyst for the reaction between the epoxy resin and the thiol compound, as a result of which the composition can be processed and cured sufficiently quickly at low temperatures, such as room temperature.

A catalyst is preferably used for the curing, i.e. the reaction of the epoxy resin with the thiol compound. As a result of the use of a catalyst, compositions are obtained which cure quickly, i.e. within a few minutes, and completely even at room temperature, which makes such compositions very attractive for use on site, for example at the construction site.

The compounds which are usually used for curing epoxy resins, can be used as catalysts, in particular those compounds which are usually used for the reactions between epoxy resins and thiol compounds, such as tertiary amines, e.g. triethylenediamine, N,N-dimethylpiperidines, benzyldimethylamine, N,N-dimethylpropylamine, triethanolamine, N,N-dimethyldipropylenetramine, 1,8-diazabicyclo[5.4.0]undec-7-ene and bis-N,N-dimethylethanolamine ether, imidazoles, e.g. 2-methylimidazole, 2-ethyl-4-methylimidazole, 2-phenylimidazoles and phenol derivatives, e.g. tris(dimethylaminomethyl)phenol, 2-[(dimethylamino)methyl]phenol, 2,4-bis[(dimethylamino)methyl]-6-methylphenol nonylphenol, and the like, which are known to the person skilled in the art, be used.

In a preferred embodiment, the compositions described herein can also use an aminophenol or an ether thereof as a catalyst, which ether has at least one tertiary amino group, optionally together with a primary and/or secondary amino group. The catalyst is preferably selected from compounds of the general formula (XX),

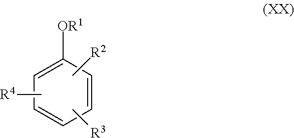

in which R¹ is hydrogen or a linear or branched C₁-C₁₅ alkyl functional group, R² is (CH₂)ₙNR⁵R⁶ or NH(CH₂)ₙNR⁵R⁶ in which R⁵ and R⁶, independently of one another, are a linear or branched C₁-C₁₅ alkyl functional group and n=0 or 1, R³ and R⁴, independently of one another, are hydrogen, (CH₂)ₙNR⁷R⁸ or NH(CH₂)ₙNR⁷, R⁸, R⁷ and R⁸ are, independently of one another, hydrogen or a linear or branched C₁-C₁₅ alkyl functional group, and n=0 or 1.

R¹ is preferably hydrogen or a C₁-C₁₅ alkyl functional group, in particular a linear C₁-C₁₅ alkyl functional group, more preferably methyl or ethyl and most preferably methyl.

The phenol of the formula (XX) is preferably substituted in the 2-, 4- and 6-position, i.e. the substituents R², R³ and R⁴ are in the 2-, 4- and 6-position.

In the case that R⁵, R⁶, R⁷ and R⁸ are alkyl functional groups, said groups are preferably a C₁-C₅ alkyl functional group, more preferably methyl or ethyl and most preferably methyl.

Either a compound or a mixture of at least two compounds of formula (XX) can be used as a catalyst.

The catalyst is preferably selected from 2,4,6-tris(dimethylaminomethyl)phenol, bis(dimethylaminomethyl)phenol and 2,4,6-tris(dimethylamino)phenol. Most preferred is the 2,4,6-tris(dimethylaminomethyl)phenol catalyst.

A preferred catalyst mixture contains 2,4,6-tris(dimethylaminomethyl)phenol and bis(dimethylaminomethyl)phenol. Such mixtures are, for example, commercially available as Ancamine® K-54 (Air Products, Belgium).

Additive which Forms an Insulating Layer

The epoxy-based composition can be an intumescent composition and contain at least one additive which forms an insulating layer. Both a single compound and a mixture of a plurality of compounds can be used as the additive which forms an insulating layer.

It is expedient for the additives which are used as additives which form an insulating layer to be of the kind that function by forming an expanded, insulating layer of flame-retardant material under the effect of heat, which layer protects the substrate from overheating, and thereby prevents or at least delays changes to the mechanical and static properties of load-bearing components due to the effect of heat. A voluminous insulating layer, specifically an ash layer, can be formed by the chemical reaction of a mixture of compounds which are matched to one another and react with one another under the effect of heat. Systems of this kind are known to a person skilled in the art as chemical intumescence and can be used according to the invention. Alternatively, the voluminous insulating layer may be formed by expansion of an individual compound which releases gases under the effect of heat, without a chemical reaction between two compounds having taken place. Systems of this kind are known to the person skilled in the art as physical intumescence and can also be used according to the invention. The two systems can each be used according to the invention either alone or together as a combination.

At least three components are generally required for forming an intumescent layer by chemical intumescence: a carbon source, a dehydrogenation catalyst, and a blowing agent, which components are contained in a binder in the case of coatings, for example. Under the effect of heat, the binder softens and the fire protection additives are released, such that said additives react with one another in the case of chemical intumescence, or can expand in the case of physical intumescence. The acid which acts as a catalyst for carbonizing the carbon source is formed from the dehydrogenation catalyst by means of thermal decomposition. At the same time, the blowing agent thermally decomposes to form inert gases which cause an expansion of the carbonized (charred) material, and optionally the softened binder, to form a voluminous, insulating foam. The components of the additive are particularly selected such that they can develop synergism, as a result of which some of the compounds can fulfill a plurality of functions.

A carbon source can be dispensed with if the binder and/or the other compounds contained in the composition can already function as a carbon source, and thus as a carbon skeleton, due to the chemical nature of said binder and/or compounds. This is the case with epoxy-based compositions, for example.

A blowing agent can be dispensed with if the binder and/or the other compounds contained in the composition, such as the curing agent, contain functional groups which, when the cured binder decomposes under the effect of heat, lead to gas formation and therefore to a foaming of the softening cured composition.

Since the composition is an epoxy-based composition which contains amine compounds, both a carbon source and a blowing agent can be dispensed with.

In one embodiment of the invention, in which the insulating layer is formed by chemical intumescence, an acid former is sufficient as the additive which forms an insulating layer. However, the composition can contain an additional carbon source and an additional blowing agent.

If a carbon source is additionally used, compounds which are usually used in intumescent fire protection formulations and are known to a person skilled in the art, such as compounds similar to starch, e.g. starch and modified starch, and/or polyhydric alcohols (polyols), such as saccharides and polysaccharides and/or a thermoplastic or duroplastic polymer resin binder, such as a phenolic resin, a urea resin, a polyurethane, polyvinyl chloride, poly(meth)acrylate, polyvinyl acetate, polyvinyl alcohol, a silicone resin and/or a rubber, can be used as a carbon source. Suitable polyols are polyols from the group of sugar, pentaerythrite, dipentaerythrite, tripentaerythrite, polyvinyl acetate, polyvinyl alcohol, sorbitol and polyethylene-/polyoxypropylene-(EO-PO-) polyols. Pentaerythrite, dipentaerythrite or polyvinyl acetate are preferably used.

Compounds which are usually used in intumescent fire protection formulations and are known to a person skilled in the art, such as a salt or an ester of an inorganic, non-volatile acid, selected from sulfuric acid, phosphoric acid or boric acid, can be used as dehydrogenation catalysts or acid formers. Phosphorus-containing compounds, the range of which is very large, are mainly used, since said compounds cover a plurality of oxidation states of phosphorus, such as phosphines, phosphine oxides, phosphonium compounds, phosphates, elemental red phosphorus, phosphites and phosphates. The following can be mentioned by way of example as phosphoric acid compounds: monoammonium phosphate, diammonium phosphate, ammonium phosphate, ammonium polyphosphate, melamine phosphate, melamine resin phosphates, potassium phosphate, polyol phosphates such as pentaerythritol phosphate, glycerol phosphate, sorbitol phosphate, mannitol phosphate, dulcitol phosphate, neopentyl glycol phosphate, ethylene glycol phosphate, dipentaerythritol phosphate and the like. A polyphosphate or an ammonium polyphosphate is preferably used as a phosphoric acid compound. In this case, melamine resin phosphates are understood to be compounds such as the reaction products of Lamelite C (melamine-formaldehyde resin) with phosphoric acid. The following can be mentioned by way of example as sulfuric acid compounds: ammonium sulfate, ammonium sulfamate, nitroaniline bisulfate, 4-nitroaniline-2-sulfonic acid and 4,4-dinitrosulfanilamide and the like. Melamine borate can be mentioned by way of example as a boric acid compound.

If a blowing agent is used, the compounds which are usually used in fire protection formulations and are known to a person skilled in the art, such as cyanuric acid or isocyanic acid and the derivatives thereof, or melamine and the derivatives thereof, can be used as blowing agents. Compounds of this kind are cyanamide, dicyanamide, dicyandiamide, guanidine and the salts thereof, biguanide, melamine cyanurate, cyanic acid salts, cyanic acid esters and cyanic acid amides, hexamethoxymethyl melamine, dimelamine pyrophosphate, melamine polyphosphate and melamine phosphate. Hexamethoxymethyl melamine or melamine (cyanuric acid amide) are preferably used.

Components which have a mode of action that is not limited to a single function are also suitable, such as melamine polyphosphate, which acts as an acid former and as a blowing agent. Further examples are described in GB 2 007 689 A1, EP 139 401 A1, and U.S. Pat. No. 3,969,291 B1.

In one embodiment of the invention, in which the insulating layer is formed by physical intumescence, the additive which forms an insulating layer comprises at least one thermally expandable compound, such as a graphite intercalation compound, which compounds are also known as expandable graphite. These can also be incorporated into the binder.

Known intercalation compounds of SOₓ, NOₓ, halogen and/or strong acids in graphite, for example, can be used as expandable graphite. These are also referred to as graphite salts. Expandable graphites which give off SO₂, SO₃, NO and/or NO₂ while expanding at temperatures of 120 to 350° C., for example, are preferred. The expandable graphite can be present, for example, in the form of flakes having a maximum diameter in the range of 0.1 to 5 mm. Said diameter is preferably in the range of 0.5 to 3 mm. Expandable graphites which are suitable for the present invention are commercially available. In general, the expandable graphite particles are evenly distributed in the fire protection elements according to the invention. The concentration of expandable graphite particles can, however, also be varied in a punctiform, pattern-like, planar and/or sandwich-like manner. In this regard, reference is made to EP 1489136 A1.

Because the ash crust formed in the event of a fire is generally too unstable, and, depending on the density and structure thereof, can be blown away by air streams, for example, which has a negative effect on the insulating effect of the coating, preferably at least one ash crust stabilizer is added to the components which have just been listed.

Ash Crust Stabilizers

The compounds which are commonly used in fire protection formulations and are known to a person skilled in the art, for example expandable graphite and particulate metals, such as aluminum, magnesium, iron, and zinc, can be used as ash crust stabilizers or skeleton formers. The particulate metal can be present in the form of a powder, flakes, scales, fibers, threads and/or whiskers, the particulate metal in the form of powder, flakes or scales having a particle size of ≤50 μm, preferably of 0.5 to 10 μm. If the particulate metal is used in the form of fibers, threads and/or whiskers, a thickness of 0.5 to 10 μm and a length of 10 to 50 μm are preferred. Alternatively or additionally, an oxide or a compound of a metal from the group comprising aluminum, magnesium, iron or zinc can be used as an ash crust stabilizer, in particular iron oxide, preferably iron troxide, titanium dioxide, a borate, such as zinc borate and/or a glass frit made of glasses which have a low melting point, having a melting temperature which is preferably at or above 400° C., phosphate or sulfate glasses, melamine polyzinc sulfates, ferrous glasses or calcium boron silicates. The addition of an ash crust stabilizer of this kind contributes to significantly stabilizing the ash crust in the event of a fire, since said additives increase the mechanical strength of the intumescent layer and/or prevent it from dripping off. Examples of additives of this kind are also found in U.S. Pat. Nos. 4,442,157 A, 3,562,197 A, GB 755 551 A, and EP 138 546 A1.

Ash crust stabilizers such as melamine phosphate or melamine borate can be contained in addition.

Flame Retardants

Optionally, one or more reactive flame retardants can be added to the composition according to the invention. Compounds of this kind are incorporated into the binder. Examples in the context of the invention are reactive organophosphorus compounds, such as 9,10-dihydro-9-oxa-10-phosphaphene-anthrene-10-oxide (DOPO) and the derivatives, such as DOPO-HQ, DOPO-NQ, and adducts of said compound. Compounds of this kind are described, for example, in S. V. Levchik, E. D. Weil, Polym. Int. 2004, 53, 1901-1929.

In addition to the additives which form an insulating layer, the composition can optionally contain conventional auxiliaries, such as solvents, for example xylene or toluene, wetting agents, for example based on polyacrylates and/or polyphosphates, defoamers, such as silicone defoamers, thickeners, such as alginate thickeners, dyes, fungicides, plasticizers, such as chlorine-containing waxes, binders, flame retardants or various fillers, such as vermiculite, inorganic fibers, quartz sand, micro glass balls, mica, silicon dioxide, mineral wool, and the like.

Additional Additives

Additional additives, such as thickeners, rheology additives, and fillers can be added to the composition. Polyhydroxycarboxylic acid amides, urea derivatives, salts of unsaturated carboxylic acid esters, alkylammonium salts of acidic phosphoric acid derivatives, ketoximes, amine salts of p-toluenesulfonic acid, amine salts of sulfonic acid derivatives, and aqueous or organic solutions or mixtures of the compounds are preferably used as rheology additives, such as anti-settling agents, anti-runoff agents, and thixotropic agents. In addition, rheology additives based on pyrogenic or precipitated silicic acids, or based on silanized pyrogenic or precipitated silicic acids can be used. The rheology additives are preferably pyrogenic silicic acids, modified and non-modified phyllosilicates, precipitated silicic acids, cellulose ethers, polysaccharides, PU thickeners and acrylate thickeners, urea derivatives, castor oil derivatives, polyamides, and fatty acid amides and polyolefins, if they are present in solid form, powdered celluloses and/or suspension agents such as xanthan gum.

Packaging

The storage-stable composition can be made up as a two-component or multi-component system.

In one embodiment of the invention, the composition prepared according to the invention is packaged as a two-component system, the epoxy resin and the mixture of the thiol compound and the amine compound being arranged separately so as to inhibit the reaction. Accordingly, a first component, component I, contains the epoxy resin, and a second component, component II, contains the thiol compound and the amine compound. This ensures that the two reactive constituents of the binder are mixed with one another, and thus trigger the curing reaction, only immediately before use. This makes the system easier to use.

In this case, the at least one epoxy resin is preferably contained in component I in an amount of from 3 to 95 wt. %, particularly preferably in an amount of from 5 to 80 wt. %.

If a reactive diluent is used, it is preferably contained in component I in an amount of from 0.25 to 70 wt. %, particularly preferably from 0.5 to 50 wt. %.

The thiol compound is preferably contained in component II in an amount of from 1 to 99 wt. %, particularly preferably in an amount of from 5 to 95 wt. %.

The additive which forms an insulating layer, or the mixture of additives which form an insulating layer, can in this case be contained in the first component I and/or a second component II as a total mixture or divided into individual constituents. The additive which forms an insulating layer, or the mixture of additives which form an insulating layer, are divided depending on the compatibility of the compounds contained in the composition, such that neither a reaction between the compounds contained in the composition, nor a mutual disturbance, nor a reaction of these compounds with the compounds of the other constituents can take place. This is dependent on the compounds used. In this way, it is ensured that the highest possible proportion of fillers can be achieved. This leads to high intumescence, even if the layer thicknesses of the composition are low.

The additive which forms an insulating layer can be contained in the composition in an amount of from 30 to 99 wt. %, wherein the amount substantially depends on the form of application of the composition (spraying, brushing, and the like). In order to bring about the highest possible intumescence rate, the proportion of the constituent C in the overall formulation is set as high as possible. The proportion of constituent C in the overall formulation is preferably 35 to 85 wt. % and particularly preferably 40 to 85 wt. %.

The composition is applied to the substrate, which is in particular metal, as a paste, using a brush, a roller, or by means of spraying. The composition is preferably applied by means of an airless spraying method.

The composition according to the invention is characterized by improved storage stability compared to such epoxy-based compositions which, in addition to amine compounds, also contain thiol compounds, the thiol compounds having ester groups.

For this reason, the two-component or multi-component, storage-stable composition prepared according to the invention is suitable as a coating, in particular as a fire protection coating, preferably a sprayable coating for substrates which are metal-based and non-metal-based. The substrates are not limited and comprise components, in particular steel components and wooden components, but also individual cables, cable bundles, cable trays, and cable ducts or other lines.

The storage-stable composition prepared according to the invention is used primarily in the construction sector as a coating, in particular a fire protection coating for steel construction elements, but also for construction elements made of other materials, such as concrete or wood, and also as a fire protection coating for individual cables, cable bundles, cable trays, and cable ducts or other lines.

The following examples serve to explain the invention in greater detail.

### EXAMPLES

In order to show the influence of the type of thiols on the storage stability of a composition based on epoxy amine, storage tests were first carried out using a simple mixture of a thiol and an amine. For this purpose, the viscosity of the relevant, freshly prepared mixture, and of the mixtures after four and after eight weeks of storage at +40° C. was determined. The storage temperature of +40° C. was chosen to simulate storage or aging of the mixture over a longer time period at room temperature.

Storage tests were also carried out using, in each case, mixtures of a thiol, an amine, melamine, ammonium polyphosphate and a wetting agent. For this purpose, the viscosity of the relevant, freshly prepared mixture, and of the mixtures after four and after eight weeks of storage at +40° C. was determined.

Storage tests were also carried out using, in each case, mixtures of a thiol, melamine or pentaerythritol or ammonium polyphosphate or titanium dioxide (TiO₂). For this purpose, the viscosity of the relevant, freshly prepared mixture, and of the mixtures after four and after eight weeks of storage at +40° C. was determined.

Compounds Used:

| | | |
|---|---|---|
| Thiocure | pentaerythritol tetra | Bruno Bock |
| PETMP | (3-mercaptopropionate) | |
| Thiocure | trimethylolpropane trimercaptoacetate | Bruno Bock |
| TMPMA | | |
| CeTePox | | CTP |
| 2200H | | |
| Polythiol | liquid resin consisting of a | Toray |
| QE 340M | polyether backbone, at the ends of | |
| | which the thiol base is introduced | |
| DBU | 1,8-diazabicyclo[5.4.0]undec-7-ene | Sigma Aldrich, TCl |
| Jeffcat | N,N,N′-trimethyl-N′-hydroxyethyl- | Huntsman |
| ZF-10 | bisaminoethylether | |
| Jeffcat | bis-(2-dimethylaminoethyl)ether 70% | Huntsman |
| ZF-22 | in dipropylene glycol | |
| DABCO | 33 wt. % of triethylenediamine | Sigma Aldrich |
| 33-LV | in dipropylene glycol | |
| PMDETA | N,N,N′,N″N″- | Sigma Aldrich |
| | pentamethyldiethylenetriamine | |
| Ancamine | 2,4,6-tri(dimethylaminomethyl) | AirProducts, Belg |
| K54 | phenol | |
| 2E4MIZ | 2-ethyl-4-methylimidazole 95% | Sigma Aldrich |
| Versamin | tertiary amine accelerator and curing | BASF |
| EH-50 | agent | |
| DBN | 1,5-diazabicyclo[4.3.0]non-5-ene | Sigma Aldrich |
| BYK-W | solution of a copolymer with filler- | BYK-Chemie GmbH |
| 903 | affinic groups | |
| APP | ammonium polyphosphate Exolit | Clariant |
| | AP 462 | |
| Melafine | 2,4,6-triamino-1,3,5-triazine | OCl nitrogen |
| | (melamine) | |
| Charmor | monopentaerythritol | Perstorp |
| PM40 | | |
| Epilox | bisphenol F-based epoxy resin | LEUNA-Harze GmbH |
| F16-01 | | |
| TiO₂ | Kronos titanium dioxide 2056 | Kronos International |
| | | Inc |
| Heloxy | 1,6-hexanediol diglycidyl ether | Momentive, Hexion |
| modifier | | |
| HD | | |

Measuring the Viscosity

The dynamic viscosity of all mixtures was measured using a cone and plate measuring system according to DIN 53019. The diameter of the cone was 20 mm and the opening angle was 1°. The measuring temperature was 23° C. (examples from table 1, table 6, and examples 47 and 48) or 40° C. (examples from table 2 and table 4, excluding examples 47 and 48). All viscosity values shown correspond to the value at 215/s. Three measuring points were established, the corresponding mean values being given in tables 1, 2, 4 and 6.

The following method was used for examples from table 1: The shear rate was increased logarithmically from 0.010/s to 500/s at 23° C. in 16 steps of 11 seconds each.

The following method was used for examples from table 2 and table 4 (excluding examples 46 and 47): Shearing took place at 40° C. in a first portion, in 7 steps of 11 seconds each at 0.100/s, 0.215/s, 0.464/s, 1.000/s, 2.154/s, 4.642/s and 10.00/s, and in a second section the shear rate was increased logarithmically from 21.54/s to 464.2/s at 40° C. in 6 steps of 8 seconds each.

For examples from table 6, and examples 46 and 47, the following method was used: The shear rate was increased logarithmically from 0.100/s to 500/s at 23° C. in 14 steps of 11 seconds each.

a) Assessment of the Storage Stability of Mixtures of a Thiol and an Amine, Based on the Viscosity and the Curing Time of the Mixtures

Tables 1 and 2 below show the viscosities of freshly prepared thiol-amine mixtures and of the thiol-amine mixtures after one, four and eight weeks of storage at +40° C.

All viscosities were measured at a shear rate of 215 s⁻¹ and a temperature of +23° C. (table 1) (cooled down to +23° C. after storage at +40° C.) or +40° C. (Table 2). The amount of the amine or amine solution is given in wt. % relative to the amount of thiol.

TABLE 1
Results of the measurement of the viscosity of the thiol-amine mixtures, measured at +23° C.

| | | | Viscosity of the | Viscosity | Viscosity | Viscosity |
|---|---|---|---|---|---|---|
| | | | Freshly prepared | after 1 week | after 4 weeks | after 8 weeks |
| Example | Thiol | Amine (wt. %) | formulation | of storage | of storage | of storage |
| 1 | Thiocure PETMP | DBU (1.1%) | 0.49 | 0.67 | 0.95 | 1.71 |
| 2 | Thiocure PETMP | Jeffcat ZF-10 (1.0%) | 0.38 | — | 0.42 | 0.62 |
| 3 | Thiocure PETMP | Jeffcat ZF-10 (6.5%) | 0.28 | — | 0.37 | 0.53 |
| 4 | Thiocure PETMP | DABCO 33-LV (6.5%) | 0.33 | 0.37 | 0.45 | 0.56 |
| 5 | Thiocure PETMP | PMDETA (6.5%) | 0.26 | 0.36 | — | 2.32 |
| 6 | TMPMA | Ancamine K54 (4.5%) | 0.13 | 0.38 | 2.37 | — |
| 7 | TMPMA | DBU (1.2%) | 0.11 | 0.51 | 2.31 | — |
| 8 | TMPMA | Jeffcat ZF-10 (2.3%) | 0.10 | 0.16 | 0.27 | — |
| 9 | TMPMA | Jeffcat ZF-22 (3.4%) | 0.09 | 0.22 | 1.2 | — |
| 10 | TMPMA | PMDETA (6.6%) | 0.11 | — | — | — |
| 11 | TMPMA | DABCO 33-LV (3.4%)* | 0.09 | 0.16 | 0.59 | — |
| 12 | TMPMA | 2E4MIZ (10.4%) | 0.21 | 2.88 | — | — |
| 13 | CeTePox 2200H | Ancamine K54 (3.1%) | 14.97 | 14.77 | 12.99 | 14.56 |
| 14 | CeTePox 2200H | Versamin EH-50 (2.3%) | 14.5 | 13.9 | 14.21 | 16.59 |
| 15 | CeTePox 2200H | Jeffcat ZF22 (2.3%) | 14.5 | 10.11 | 10.6 | 11.49 |
| 16 | CeTePox 2200H | Jeffcat ZF10 (1.6%) | 11.91 | 10.71 | 9.95 | 11.78 |
| 17 | CeTePox 2200H | DBU (1.6%) | 19.64 | 18.79 | 23.28 | 41.54 |
| 18 | CeTePox 2200H | DABCO (2.3%) | 13.01 | 11.74 | 9.93 | 12.05 |
| 19 | Polythiol QE 340M | Ancamin K54 (4.5%) | 13.74 | 13.85 | 14.54 | 15.43 |
| 20 | Polythiol QE 340M | DBN (1.6%) | 16.92 | 19.35 | 25.10 | 41.97 |
| 21 | Polythiol QE 340M | Jeffcat ZF-10 (1.6%) | 12.25 | 11.82 | 13.35 | 13.64 |
| 22 | Polythiol QE 340M | Jeffcat ZF-22 (2.3%) | 10.94 | 11.42 | 12.07 | 13.26 |
| 23 | Polythiol QE 340M | DBU (1.6%) | 16.33 | 17.79 | 24.11 | 31.40 |
| 24 | Polythiol QE 340M | DABCO 33-LV (2.3%)* | 11.59 | 11.74 | 12.67 | 13.68 |
| 25 | Polythiol QE 340M | Versamin EH-50 (2.3%) | 14.01 | 14.43 | 15.71 | 17.31 |
| 26 | Polythiol QE 340M | DBN (0.79%) | 15.50 | 17.71 | 19.13 | 21.75 |
| 27 | Polythiol QE 340M | DBU (0.79%) | 14.84 | 15.89 | 16.60 | 17.71 |

*based on the solution (=DABCO 33-LV)

TABLE 2
Viscosities of the thiol-amine mixtures, measured at +40° C.

| | | | Viscosity of the | Viscosity | Viscosity | Viscosity |
|---|---|---|---|---|---|---|
| | | | freshly prepared | after 1 week | after 4 weeks | after 8 weeks |
| Example | Thiol | Amine (wt. %) | formulation | of storage | of storage | of storage |
| 28 | Thiocure PETMP | DBU (1.1%) | 0.17 | 0.21 | 0.28 | 0.42 |
| 29 | Thiocure PETMP | Jeffcat ZF-10 (2.3%) | 0.12 | 0.13 | 0.15 | 0.15 |
| 30 | Thiocure PETMP | PMDETA (6.5%) | 0.10 | 0.12 | 0.22 | 0.50 |
| 31 | TMPMA | DBU (1.2%) | 0.05 | 0.13 | 0.50 | 1.00 |
| 32 | TMPMA | Jeffcat ZF-10 (2.3%) | 0.04 | 0.06 | 0.14 | 0.27 |
| 33 | TMPMA | DABCO 33-LV (3.4%)* | 0.04 | 0.06 | 0.11 | 0.15 |
| 34 | CeTePox 2200H | Ancamine K54 (3.1%) | 2.0 | 2.0 | 2.0 | 2.0 |
| 35 | CeTePox 2200H | Jeffcat ZF-10 (1.6%) | 1.78 | 1.73 | 1.85 | 1.67 |
| 36 | CeTePox 2200H | DABCO 33-LV (2.3%) | 1.84 | 1.85 | 1.89 | 1.79 |
| 37 | Polythiol QE 340M | Ancamin K54 (4.5%) | 2.80 | 2.77 | 3.0 | 3.0 |
| 38 | Polythiol QE 340M | Jeffcat ZF-10 (1.6%) | 2.55 | 2.45 | 2.80 | 2.37 |

*based on the solution (=DABCO 33-LV)

In order to determine how the storage stability of the mixtures of the examples from table 1 affects the curing, the mixtures, after they had been cooled down to room temperature (+23° C.), were cured by mixing at room temperature (+23° C.) with fresh epoxy resin (Epilox F 16-01). The amount of epoxy resin was calculated such that a stoichiometrc reaction could take place (functional ratio of epoxy:amine=1:1).

TABLE 3
Curing times of the mixtures from table 1 in minutes [min]

| | | | Curing time of a | Curing time | Curing time | Curing time |
|---|---|---|---|---|---|---|
| | | | freshly prepared | after 1 week | after 4 weeks | after 8 weeks |
| Example | Thiol | Amine | mixture | of storage | of storage | of storage |
| 1 | Thiocure PETMP | DBU (1.1%) | 1.7 | 3 | 2.5 | 4 |
| 2 | Thiocure PETMP | Jeffcat ZF-10 (1.0%) | 17 | — | 56 | >1440 |
| 3 | Thiocure PETMP | Jeffcat ZF-10 (6.5%) | 9 | — | 17 | 44 |
| 4 | Thiocure PETMP | DABCO 33-LV (6.5%)* | 4 | 5 | 6 | 10 |
| 5 | Thiocure PETMP | PMDETA (6.5%) | 6 | 7 | 14 | 38 |
| 6 | TMPMA | Ancamine K54 (4.5%) | 10 | 14 | 50 | — |
| 7 | TMPMA | DBU (1.2%) | 4 | 5 | 19 | — |
| 8 | TMPMA | Jeffcat ZF-10 (2.3%) | 16 | 45 | >900 | — |
| 9 | TMPMA | Jeffcat ZF-22 (3.4%) | 10 | 15 | 51 | — |
| 10 | TMPMA | PMDETA (6.6%) | 4 | — | — | — |
| 11 | TMPMA | DABCO 33 LV (3.4%) | 8 | 16 | >900 | — |
| 12 | TMPMA | 2E4MIZ (10.4%) | 4 | >900 | — | — |
| 13 | CeTePox 2200H | Ancamine K54 (3.1%) | 9 | 9 | 9 | 12 |
| 14 | CeTePox 2200H | Versamin EH-50 (2.3%) | 9 | 9 | 10 | 10 |
| 15 | CeTePox 2200H | Jeffcat ZF22 (2.3%) | 6 | 8 | 9 | 10 |
| 16 | CeTePox 2200H | Jeffcat ZF10 (1.6%) | 8 | 10.5 | 10 | 10 |
| 17 | CeTePox 2200H | DBU (1.6%) | 1 | 1 | 1 | 1 |
| 18 | CeTePox 2200H | DABCO 33 LV (2.3%)* | 5 | 5 | 5 | 5 |
| 19 | Polythiol QE 340M | Ancamin K54 (4.5%) | 15 | 13 | 13 | 13 |
| 20 | Polythiol QE 340M | DBN (1.6%) | 1 | 2 | 2 | 2 |
| 21 | Polythiol QE 340M | Jeffcat ZF-10 (1.6%) | 32 | 25 | 32 | 32 |
| 22 | Polythiol QE 340M | Jeffcat ZF-22 (2.3%) | 24 | 14 | 16 | 17 |
| 23 | Polythiol QE 340M | DBU (1.6%) | 2 | 3 | 2 | 3 |
| 24 | Polythiol QE 340M | DABCO 33-LV (2.3%)* | 5 | 8 | 9 | 8 |
| 25 | Polythiol QE 340M | Versamin (2.3%) | 18 | 20 | 23 | 22 |
| 26 | Polythiol QE 340M | DBN (0.79%) | 2 | 12 | 46 | 71 |
| 27 | Polythiol QE 340M | DBU (0.79%) | 4 | 44 | — | 137 |

*based on the solution (=DABCO 33-LV)

b) Assessment of the Storage Stability of Mixtures of an Ester Group-Free Thiol and Inorganic Fillers on the Basis of the Viscosity and the Curing Time of the Mixtures

Table 4 below shows the viscosities of freshly prepared thiol-amine-filler mixtures and of the thiol-amine-filler mixtures after one, four and eight weeks of storage at +40° C. The mixture in example 46 corresponds to the mixture in example 47, which was stored at +23° C. instead of +40° C.

All viscosities were measured at a shear rate of 215 s⁻¹ and a temperature of +40° C. The amount of the amine is given in wt. % relative to the amount of thiol.

TABLE 4
Viscosities [Pa · s] of the thiol-amine filler mixtures, measured at +40° C.

| Example | | | | Viscosity of the | Viscosity | Viscosity | Viscosity |
|---|---|---|---|---|---|---|---|
| (storage | | | | freshly prepared | after 1 week | after 4 weeks | after 8 weeks |
| temperature) | Thiol | Amine | Filler(s) | formulation | of storage | of storage | of storage |
| 39 | Thiocure | DBU (0.5%) | Byk W 903 (1%) | 4.33 | 5.48 | 13.84 | 10.01 |
| (40° C.) | PETMP | | APP (15%) | | | | |
| | | | Melafine (15%) | | | | |
| | | | TiO₂ (15%) | | | | |
| | | | Charmor PM 40 (15%) | | | | |
| 40 | Thiocure | Pmdeta | Byk W 903 (1%) | 2.17 | 3.14 | 5.98 | 8.84 |
| (40° C.) | PETMP | (2.5%) | APP (15%) | | | | |
| | | | Melafine (15%) | | | | |
| | | | TiO2 (15%) | | | | |
| | | | Charmor PM 40 (15%) | | | | |
| 41 | Thiocure | DBU (0.5%) | Byk W 903 (1%) | 2.01 | 4.39 | 9.68 | 10.66 |
| (40° C.) | TMPMA | | APP (15%) | | | | |
| | | | Melafine (15%) | | | | |
| | | | TiO₂ (15%) | | | | |
| | | | Charmor PM 40 (15%) | | | | |
| 42 | Thiocure | DABCO 33- | Byk W 903 (1%) | 1.43 | 10.21 | 3.00 | 2.79 |
| (40° C.) | TMPMA | LV (1.3%) | APP (15%) | | | | |
| | | | Melafine (15%) | | | | |
| | | | TiO₂ (15%) | | | | |
| | | | Charmor PM 40 (15%) | | | | |
| 43 | CeTePox | Ancamine | Byk W 903 (1%) | 15.40 | 17.09 | 48.25 | 11.66 |
| (40° C) | 2200H | K54 (1%) | APP (14%) | | | | |
| | | | Melafine (14%) | | | | |
| | | | TiO₂ (14%) | | | | |
| | | | Charmor PM 40 (14%) | | | | |
| 44 | CeTePox | DABCO 33- | Byk W 903 (0.9%) | 9.77 | 22.74 | 42.25 | 16.32 |
| (40° C.) | 2200H | LV (1%) | APP (13%) | | | | |
| | | | Melafine (13%) | | | | |
| | | | TiO₂ (13%) | | | | |
| | | | Charmor PM 40 (13%) | | | | |
| 45 | Polythiol | Ancamine | Byk W 903 (0.9%) | 13.92 | 15.56 | 16.38 | 10.24 |
| (40° C.) | QE | K54 (2.2%) | APP (13%) | | | | |
| | 340M | | Melafine (13%) | | | | |
| | | | TiO₂ (13%) | | | | |
| | | | Charmor PM 40 (13%) | | | | |
| 46 | CeTePox | DABCO 33- | Byk W 903 (1%) | 23.84 | 22.31 | 22.57 | 20.77 |
| (23° C.) | 2200H | LV (0.2%)* | APP (30%) | | | | |
| | | | Melafine (30%) | | | | |
| 47 | CeTePox | DABCO 33- | Byk W 903 (1%) | 23.84 | 22.48 | 22.84 | 22.19 |
| (40° C.) | 2200H | LV (0.2%) | APP (30%) | | | | |
| | | | Melafine (30%) | | | | |

*based on the solution (=DABCO 33-LV)

In order to determine how the storage stability of the thiol-amine-filler mixtures from examples 39 to 47 affects the curing, the mixtures from examples 39 to 45, after they had been cooled down to room temperature (+23° C.), were mixed at room temperature (+23° C.) with fresh epoxy resin (Epilox F 16-01). The amount of epoxy resin was calculated such that a stoichiometric reaction could take place (functional ratio of epoxy:amine=1:1).

The thiol-amine-filler mixture in examples 46 and 47 was not cured using a freshly prepared epoxy resin, but instead using an aged epoxy composition. For this purpose, the thiol-amine mixture of examples 46 and 47 was mixed with 26 wt. % Epilox F16-01, 20 wt. % Charmor PM 40, 20 wt. % Exolit AP 462, 20 wt. % Kronos 2056, 13 wt. % Heloxy modifier HD and 1 wt. % BYK W-903.

The curing times were determined at 23° C.

TABLE 5
Curing times in minutes [min] for the mixtures from Examples 39 to 47

| | | | | Curing time of a | Curing time | Curing time | Curing time |
|---|---|---|---|---|---|---|---|
| | | | | freshly prepared | after 1 week | after 4 weeks | after 8 weeks |
| Example | Thiol | Amine | Filler(s) | mixture | of storage | of storage | of storage |
| 39 | Thiocure | DBU (0.5%) | Byk W 903 (1%) | 2.5 | 4.5 | 6 | 7 |
| (40° C.) | TMPMA | | APP (15%) | | | | |
| | | | Melafine (15%) | | | | |
| | | | TiO₂ (15%) | | | | |
| | | | Charmor PM 40 (15%) | | | | |
| 40 | Thiocure | PMDETA | Byk W 903 (1%) | 5 | 12.5 | 21 | 39 |
| (40° C.) | PETMP | (2.5%) | APP (15%) | | | | |
| | | | Melafine (15%) | | | | |
| | | | TiO₂ (15%) | | | | |
| | | | Charmor PM 40 (15%) | | | | |
| 41 | Thiocure | DBU (0.5%) | Byk W 903 (1%) | 3 | 10 | 1440 | >4320 |
| (40° C.) | TMPMA | | APP (15%) | | | | |
| | | | Melafine (15%) | | | | |
| | | | TiO₂ (15%) | | | | |
| | | | Charmor PM 40 (15%) | | | | |
| 42 | Thiocure | DABCO 33- | Byk W 903 (1%) | 7.5 | 55 | >4320 | >4320 |
| (40° C.) | TMPMA | LV (1.3%)* | APP (15%) | | | | |
| | | | Melafine (15%) | | | | |
| | | | TiO₂(15%) | | | | |
| | | | Charmor PM 40 (15%) | | | | |
| 43 | CeTePox | Ancamine | Byk W 903 (1%) | 11 | 10 | 12 | 12.5 |
| (40° C.) | 2200H | K54 (1%) | APP (14%) | | | | |
| | | | Melafine (14%) | | | | |
| | | | TiO₂ (14%) | | | | |
| | | | Charmor PM 40 (14%) | | | | |
| 44 | CeTePox | DABCO 33- | Byk W 903 (0.9%) | 4 | 6 | 8 | 8 |
| (40° C.) | 2200H | LV (1%) | APP (13%) | | | | |
| | | | Melafine (13%) | | | | |
| | | | TiO₂(13%) | | | | |
| | | | Charmor PM 40 (13%) | | | | |
| 45 | Polythiol | Ancamine | Byk W 903 (0.9%) | 12 | 14 | 20 | 18 |
| (40° C.) | QE | K54 (2.2%) | APP (13%) | | | | |
| | 340M | | Melafine (13%) | | | | |
| | | | TiO₂ (13%) | | | | |
| | | | Charmor PM 40 (13%) | | | | |
| 46 | CeTePox | DABCO 33- | Byk W 903 (1%) | 140 | 167 | 126 | 144 |
| (23° C.) | 2200H | LV (0.2%) | APP (30%) | | | | |
| | | | Melafine (30%) | | | | |
| 47 | CeTePox | DABCO 33- | Byk W 903 (1%) | 128 | 156 | 127 | 154 |
| (40° C.) | 2200H | LV (0.2%) | APP (30%) | | | | |
| | | | Melafine (30%) | | | | |

*Based on the solution (= DABCO 33-LV)

c) Assessment of the Storage Stability of Mixtures of an Ester Group-Free Thiol and Individual Inorganic Fillers One the Basis of the Viscosity of the Mixtures

Table 6 below shows the viscosities of the freshly prepared thiol-filler mixtures and of the thiol-filler mixtures after one, four and eight weeks of storage at +40° C., in order to clarify that the reduced storage stability is due to the interaction of thiol with amine, and not due to an interaction of thiol with filler.

All viscosities were measured at a shear rate of 215 s⁻¹ and a temperature of +23° C.

TABLE 6
Viscosities of the thiol-filler mixtures, measured at +23° C.

| | | | Viscosity of the | Viscosity | Viscosity | Viscosity |
|---|---|---|---|---|---|---|
| | | | freshly prepared | after 1 week | after 4 weeks | after 8 weeks |
| Example | Thiol | Filler | formulation | of storage | of storage | of storage |
| 48 | CeTePox | Melafine (12.5%) | 12.77 | 13.33 | 13.27 | 13.04 |
| 49 | 2200H | TiO₂ (12.5%) | 9.60 | 10.09 | 10.95 | 10.04 |
| 50 | | APP (25%) | 18.31 | 16.22 | 15.23 | 13.07 |
| 51 | | Charmor (12.5%) | 13.71 | 12.87 | 13.51 | 14.02 |

1: A method of improving the storage stability of a composition containing amine compounds, the method comprising:
mixing an ester group-free thiol compound into the composition.

2: The method according to claim 1, wherein the thiol compound has at least two thiol groups.

3: The method according to claim 1, wherein the composition is an epoxy-based composition.

4: The method according to claim 1, wherein thiol groups of the thiol compound are bound to a monomer, an oligomer, or a polymer, as a skeleton.

5: The method according to claim 4, wherein the thiol compound is selected from the group consisting of a liquid 2-hydroxy-3-mercapto-1-propyl-substituted aliphatic alcohol, which is optionally ethoxylated or propoxylated, tris-(2′-hydroxy-3′-mercaptopropyl)-trimethylol propane, ethoxylated tris-(2′-hydroxy-3′-mercaptopropyl)-trimethylol propane, propoxylated tris-(2′-hydroxy-3′-mercaptopropyl)-trimethylol propane, 1,6-hexanedithiol, dithioglycerol, trithioglycerol, poly(ethylene glycol) methyl ether thiol, 2-[(3-aminopropyl)amino]ethanethiol, 3-aminopropane-1-thiol, dithiothreitol, a phenylic thiol, a benzylic thiol, hexadecanedithiol, tetra(ethylene glycol) dithiol, 2-methylsulfanylpropane-1,3-dithiol, 3-ethoxypropane-1,2-dithiol, 3-aminopropane-1,2-dithiol, 3-anilinopropane-1,2-dithiol, and a liquid thiol-terminated polysulfide polymer.

6: The method according to claim 1, wherein the composition contains an epoxy resin which has at least two epoxy groups.

7: The method according to claim 6, wherein the epoxy resin can be obtained by reacting a polyhydroxy compound with an epihalohydrin or a precursor thereof, and has an epoxy equivalent weight (EEW)≤550 g/val.

8: The method according to claim 7, wherein the polyhydroxy compound is selected from the group consisting of polyvalent phenols.

9: The method according to claim 8, wherein the polyhydroxy compound is bisphenol A, bisphenol F, or a mixture thereof.

10: The method according to claim 6, wherein the composition further contains a catalyst for a reaction of the epoxy resin with the thiol compound.

11: The method according to claim 3, wherein the epoxy-based composition is an intumescent composition.

12: The method according to claim 1, wherein the composition contains at least one additive which forms an insulating layer.

13: The method according to claim 12, wherein the A least one additive which forms an insulating layer is a compound selected from the group consisting of a carbon source, an acid former, a blowing agent, a thermally expandable compound, and a combination of two or more thereof.

14: The method according to claim 13, wherein the composition further contains at least one ash crust stabilizer.

15: The method according to claim 1, wherein the composition further contains organic and/or inorganic aggregates and/or further additives.

16: The method according to claim 5, wherein the thiol compound is a benzenedithiol or dimercaptostilbene.
